(19) United States
(12) Patent Application Publication
(10) Pub. No.: US 2019/0094939 A1
(43) Pub. Date: Mar. 28, 2019

(54) METHOD AND APPARATUS FOR PREEMPTIVELY SCALING TRANSACTIONS TO MINIMIZE POWER VIRUS EFFECTS

(71) Applicant: QUALCOMM Incorporated, San Diego, CA (US)

(72) Inventors: Hans Yeager, Chapel Hill, NC (US); Thomas Basnight, Raleigh, NC (US); Zainab Nasreen Zaidi, Raleigh, NC (US); Cesar Aaron Ramirez, Hutto, TX (US)

(21) Appl. No.: 15/713,105

(22) Filed: Sep. 22, 2017

(51) Int. Cl. G06F 1/32

(52) U.S. Cl. CPC G06F 1/3206; G06F 1/3287; G06F 1/3234

(57) ABSTRACT

A method and apparatus is disclosed for minimizing power virus in a network on chip. The method includes an operational metric related to a node with at least one threshold, the node configured to manage communication of a first number of outbound transactions; determining, based on the comparison, a second number of outbound transactions from the first number of outbound transactions that are allowed from the node; and communicating the second number of outbound transactions. An apparatus for minimizing power virus in a network on chip is also disclosed.

### BACKGROUND

### Field

Aspects of the present disclosure relate generally to network on chips, and more particularly, to a method and apparatus for preemptively scaling transactions to minimize power virus effects.

### Backgrounds

Complex System-on-Chips (SoCs) can include a variety of components such as multiple processor cores, graphics and specialized hardware accelerators, memory and I/O subsystems including communications interfaces. As the number of components integrated into an SoC continues to rise due to increasing levels of integration, system complexity, and shrinking transistor geometry, it becomes more challenging to provide high-performance (e.g., high bandwidth and low latency) communications functionality between these various components. Traditional buses and crossbar-based interconnects have scalability issues and, as a result, new interconnection approaches such as Network-on-Chip (NoC) have emerged to provide communication for the large number of components on the chip.

In general, a NoC is a communication infrastructure made up of interconnected routing nodes, where nodes are connected to each other using point-to-point physical links at multiple ports. This communication infrastructure is shared between the various components in the SoC. A large NoC (i.e., one interconnecting many components), which has many wires and spans long distances on die, can consume a significant amount of current when operating at a desired voltage and frequency. A worst-case scenario, referred to as a power virus, occurs when the NoC consumes close to a maximum amount of current for which its Power Delivery Network (PDN) is capable of providing. This leads to severe voltage droops that can often lead to circuit failures because of unpredictable transients.

Rapid current change events are known to cause on-die voltage droops and overshoots due to the inductance, resistance, and capacitance characteristics of the PDN that is used to carry current from the voltage regulator to on-die components like a NoC. Typically, to achieve a desired frequency of operation with reasonable power consumption, voltage droops must be constrained to a relatively small value compared to a target operating voltage.

Voltage droops are typically managed by design teams in one of several ways, including optimizing PDN characteristics. In this approach, an attempt is made in a particular PDN design to minimize package inductance and increase on-die on-package decoupling capacitance of the corresponding voltage supply. However, achieving both of these goals will tend to increase the package and die costs of the end product.

Another typical approach attempts to prevent too many systems (such as CPUs in a multi-CPU system) from turning on all at once. While this approach addresses rapid current change events associated with transitioning from no activity to some activity, it does not handle scenarios where a CPU that is already running has rapid changes in current consumption.

Reactive approaches try to sense a voltage droop event and then reduce the amount of current being consumed using a variety of methods (e.g., frequency scaling). These approaches generally suffer from having a response latency that is still too slow and also work only for a relatively small domain, where the voltage droop is observed and experienced more uniformly on-die (like in a CPU or GPU), but not for a large, clock-synchronous domain such as that found on a NoC. Although the NoC may be split into multiple smaller domains—each running on their own clock, the split will introduce asynchronous clock crossings in the NoC that ultimately reduces NoC performance.

Other approaches employ various circuit and schemes for encoding communications to minimize current consumption during each cycle. These schemes require logic to: 1) make a determination of what encoding should be employed; 2) perform encoding before starting to send the data; and 3) perform decoding at the receiving end of the data. Thus, these schemes also introduce latency. Further, these schemes generally work better for point-to-point transfers over large distances rather than in a NoC because the NoC generally has multiple ports at each node and so the data transmitted across any segment between nodes may change from cycle to cycle depending on the NoC routing employed.

Consequently, it would be desirable to address the issues discussed above.

### SUMMARY

The following presents a simplified summary of one or more aspects of the disclosed method and apparatus for preemptively scaling transactions to minimize power virus effects in order to provide a basic understanding of such aspects. Various aspects of the preemptive scaling of transactions disclosed herein minimizes any negative effects due to power viruses, such as severe voltage droop issues, while minimizing any performance impact that may be caused by scaling transactions. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In a particular example, a method for minimizing power virus in a network on chip includes comparing an operational metric related to a node with at least one threshold, the node configured to manage communication of a first number of outbound transactions; determining, based on the comparison, a second number of outbound transactions from the first number of outbound transactions that are allowed from the node; and communicating the second number of outbound transactions.

In another particular example, an apparatus for minimizing power virus in a network on chip includes a metrics monitor including an operational metric related to a node configured to manage communication of a first number of outbound transactions. The apparatus also includes a processing system configured to compare the operational metric with at least one threshold; and determine, based on the comparison, a second number of outbound transactions from the first number of outbound transactions that are allowed from the node. The apparatus further includes a transaction scaling module configured to communicate the second number of outbound transactions.

In another particular example, an apparatus for minimizing power virus in a network on chip includes means for comparing, with at least one threshold, an operational metric related to a node configured to manage communication of a first number of outbound transactions; and means for determining, based on the comparison, a second number of outbound transactions from the first number of outbound transactions that are allowed from the node. The apparatus further includes a set of transmission interfaces configured to communicate the second number of outbound transactions.

In another particular example, a computer program product having a computer-readable storage medium that includes code for comparing an operational metric related to a node with at least one threshold, the node configured to manage communication of a first number of outbound transactions; determining, based on the comparison, a second number of outbound transactions from the first number of outbound transactions that are allowed from the node; and communicating the second number of outbound transactions.

These and other aspects of the present disclosure will become more fully understood upon a review of the detailed description, which follows.

### BRIEF DESCRIPTION OF THE DRAWINGS

These and other sample aspects of the disclosure will be described in the detailed description that follow, and in the accompanying drawings.

FIG. 1 is a topological diagram of a Network-on-Chip (NoC) with routing nodes configured in a bi-directional ring topology in which various aspects of the disclosure may be implemented.

FIG. 2 is another topological diagram of a NoC with routing nodes configured in a two-dimensional (2D) mesh topology in which various aspects of the disclosure may be implemented.

FIG. 3 is still another topological diagram of a NoC with routing nodes configured in a 2D torus topology in which various aspects of the disclosure may be implemented.

FIG. 4 is a block diagram of a routing node configured as a four (4)-way node with both inbound and outbound virtual channels for each port in which various aspects of the disclosure may be described.

FIG. 5 is a diagram with the routing node of FIG. 4 coupled to other routing nodes.

FIG. 6 is a block diagram of the routing node of FIG. 4 detailing various aspects of the disclosure for preemptive transaction scaling that includes a preemptive scaling module (PSM) that is coupled to, for each port, a set of arbitration and control modules for outbound virtual channels and a set of activity monitors for inbound virtual channels.

FIG. 7 is a block diagram of a sets of activity monitors for the inbound virtual channels of the port of FIG. 8.

FIG. 8 is a block diagram of a set of arbitration and control modules for the outbound virtual channels of a port.

FIG. 9 is a block diagram of a PSM configured in accordance with aspects of the disclosure for preemptive transaction scaling.

FIG. 10 is a flow diagram of a preemptive transaction scaling operation of the PSM of FIG. 9 configured in accordance with various aspects of the disclosure.

FIG. 11 is a flow diagram of a virtual channel throttling determination process of the PSM of FIG. 9 configured in accordance with various aspects of the disclosure.

FIG. 12 is a block diagram detailing a first preemptive transaction scaling configuration using the PSM of FIG. 9 for a virtual channel of a particular port.

FIG. 13 is a block diagram detailing the first preemptive transaction scaling configuration of FIG. 12 for another virtual channel of the port of FIG. 12.

FIG. 14 is a block diagram detailing a second preemptive transaction scaling configuration using the PSM of FIG. 9 for a set of transmit interfaces.

FIG. 15 is a block diagram detailing the second preemptive transaction scaling configuration of FIG. 14 in a 4-way switching node with multiple busses.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts disclosed herein. However, it will be apparent to those skilled in the art that these concepts may be practiced without these specific details. In some instances, well known structures and components are shown in block diagram form in order to avoid obscuring such concepts.

A significant amount of the total power consumed by the NoC comes from current consumption while the NoC is transferring data and messages between different entities on the network. With large data paths having significant wire capacitance and buffer effects, high amounts of current may be consumed, especially at high peak bandwidth use. However, active NoC power consumption depends not only on the amount of traffic (or bandwidth that is being used) in the NoC, but also on the patterns of data and messages that are being transmitted. Specifically, current consumption that is attributable to data transmissions is heavily affected by how those data transmissions are patterned from cycle to cycle. For example, when only arbitration and packet/control/routing overhead logic are being toggled in the NoC, no significant amount of power is consumed because all data patterns are 0x0s (all zeros). However, significant data wire power, which can more than double total power consumption, is added when data patterns such as 0xA-0x5 occur. In some instances, even at half of a peak bandwidth, a large difference in current consumption has been measured between all zeros and an 0xA-0x5 data pattern.

Unfortunately, data patterns are workload dependent and cannot be known a priori. This is exacerbated in situations where computing resources on a single SoC are being provided to several entities—each of whom uses different portions of the resources on a single chip. This not only creates a situation where significant current consumption events may occur in the NoC; but more importantly, due to the data pattern dependencies, the amount of current consumption may change rapidly from very high to very low (or vice versa) in very short periods of time. For a NoC running well over multiple gigahertz such as 2 GHz, these periods may be as short as just a couple of clock cycles (or 500 pS). Thus, rapid current change events exceeding tens of amps every nanosecond may occur if data dependencies across the NoC all happen to change simultaneously. As used herein, the term “rapid current change event” (δi/δt) may refer to a change in current consumption (δi) over a particular period of time (δt).

As discussed, rapid current change events may cause both voltage droops and overshoots and, to achieve a desired frequency of operation with reasonable power consumption, a target operating voltage level should be maintained in the NoC. Any deviation, such as those caused by voltage droops, must be constrained to a relatively small value from this target or, if the SoC in which the NoC is located is capable of operating at different voltage set-points, other voltage set-points. A frequency of operation where there is zero or no chance of failure thus depends on the voltage set-point minus the worst-case voltage droop that may be experienced by the voltage domain of the NoC based on a power virus. Generally a “power virus” refers to a sustainable high power or high current consumption state. As used herein, the term “power virus” may also refer to a rapid current change event that may cause a voltage droop severe enough to potentially affect reliable operation of the NoC (“severe current change event”). The term may further also refer to an occurrence of the voltage droop itself.

Various aspects of the disclosed method and apparatus for preemptively scaling transactions to minimize power virus effects provide for a preemptive scaling of a number of outbound transactions that are allowed by a node in a NoC. As used herein, the term “transaction” may apply to communication of information, including data and/or messages, from the node to a recipient in one or more cycles. The information may include one or more bits that are associated with one or more packets or other grouping of bits arranged in particular patterns of bits (or, simply, bit patterns). Because the communication of these bit patterns from the node to a recipient is effected by a toggling (switching) of one or more wires, the term “transaction” may also apply to the toggling of one or more wires. It should be noted that although the various examples used herein refers to each transaction occurring in a single cycle, those skilled in the art would understand that a transaction may span multiple cycles. In its most basic form, the disclosure for preemptive transaction scaling provides for management of the toggling of one or more wires to minimize occurrences of power viruses.

In one aspect of the disclosure, preemptive transaction scaling may be implemented to reduce power viruses by preemptively limiting transactions when necessary, such as by ensuring that only so many wires leaving any node in the NoC can switch, or be toggled, in any given cycle. This preemptive transaction limitation minimizes occurrences of worst-case rapid current change events that may be experienced by the voltage domain of the NoC—independent of data patterns existing in the workload. Any impact on performance, such as in cases where a node wants, but is not able, to send messages on all possible busses, is minimized by limiting transactions only when necessary such that, in most cases, very few, if any, transactions would be blocked. Moreover, data and packet loss for any blocked transactions may be prevented using ticketing, retry, or other backpressure mechanisms.

As used herein, the term “scaling” may refer to a throttling of transactions by limiting, or blocking, of one or more transactions from occurring. However, the term may also refer to determining a number of transactions that may be allowed to occur, whether that number is higher or lower than a desired number of transactions. Thus, preemptive transaction scaling may refer to both preemptively limiting and allowing transactions, the latter being just as important because ultimately the performance of the NoC should be maintained at the highest possible level.

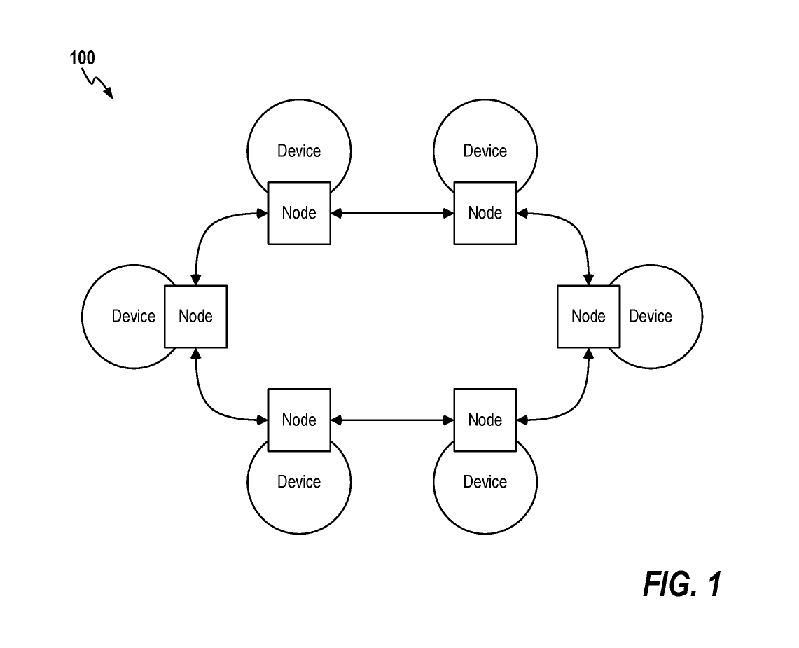

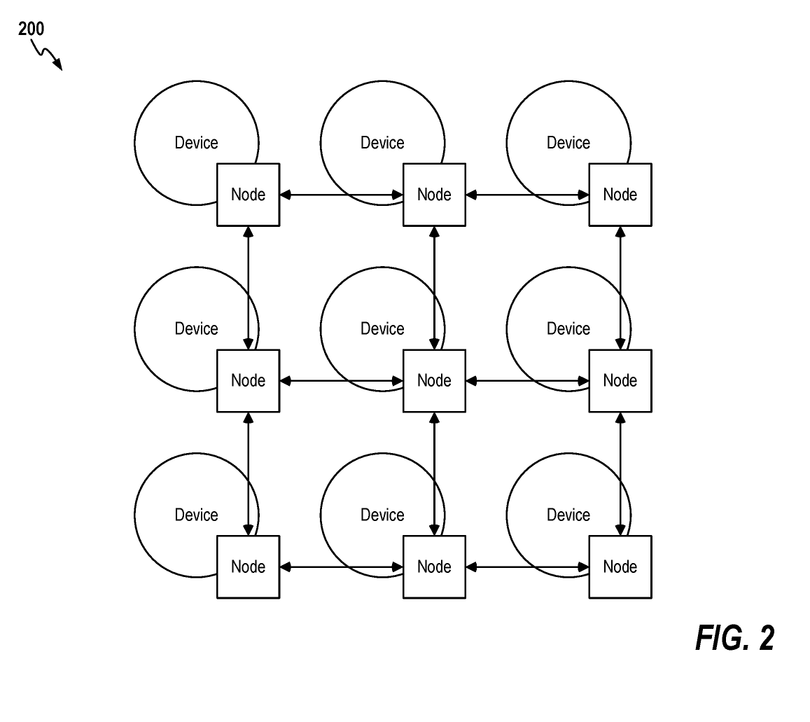

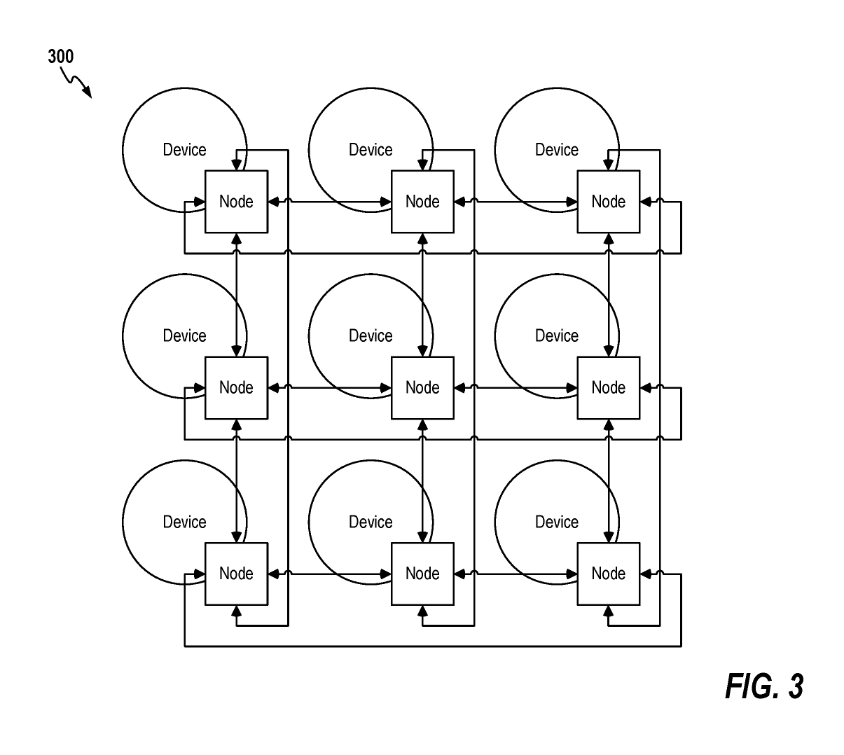

In another aspect of the disclosure, control of the preemptive transaction scaling to prevent worst-case rapid current change events occurs at a node level of a mesh of the NoC, where each node is responsible for monitoring and scaling outgoing transactions to adjacent nodes. As such, adjacent nodes are only responsible for handling incoming transactions and their own outgoing transactions. By making decisions for preemptive transaction scaling locally in the node, time lag is reduced because there is no need to consider the whole mesh. Consequently, the preemptive transaction scaling provided by the present disclosure operates and acts almost immediately; on the order of one-to-n cycles, where n is a small, single digit value. Further, by limiting the preemptive transaction scaling considerations to the node level and effectively removing considerations for the specific topology of the NoC, various aspects of the disclosure for preemptive transaction scaling may be applied to any NoC topology. For example, FIG. 1 illustrate a bi-directional ring 100 in which a plurality of nodes may be organized; FIG. 2 illustrates a plurality of nodes configured as a 2D mesh 200, and FIG. 3 illustrates a plurality of nodes arranged as a torus 300. Although a detailed discussion of routing is unnecessary for understanding various aspects of the disclosure, a brief and general overview is provided herein.

Communication between different devices over the NoC may include operations of reading or writing bytes of data from or to addresses in a memory space. These operations are generally composed of a request which goes from an initiator to a target and contains at least the address and data in the case of a write operation; and a response flowing back from the target to the initiator, with some status and data in case of read operation. Packets are message transport units for intercommunication in the SoC and routing them through the SoC involves identifying a path composed of a set of routers (nodes) and physical links of the SoC over which packets are sent from a source to a destination (that may include multiple devices). Because devices are connected to one or multiple ports of one or multiple routers, where each port may have a unique ID, all packets include a destination node and port ID information for use by any intermediate node to route the packet to the destination. Thus, packets are injected into the routing mesh by the source and are routed from a source node to a destination node over one or more intermediate nodes on physical links. The destination node then ejects the message and provides the message to the destination. As used herein, the term “devices” may be used interchangeably to refer to the various SoC functional blocks, components, hosts, or cores, that are interconnected using a NoC. Further, terms such as “routers” and “nodes” should be understood to be interchangeably used.

In yet another aspect of the disclosure, preemptive transaction scaling may be considered based on operating parameters such as frequency and bandwidth operating points of the NoC, and in general, the SoC. Thus, for example, preemptive transaction scaling in the form of preemptive transaction limiting may be effected at high frequency and high potential bandwidth operating points. However, the limiting of transactions may be relaxed or even completely removed in certain situations. For example, transactions may not be blocked when the available bandwidth is not being fully utilized. In addition, at lower frequency operating points, even utilization of all available bandwidth in the NoC, which depends on the operating frequency, may not cause a power virus capable of a rapid current change event that would cause a circuit failure, as further described herein. Thus, the amount of preemptive transaction scaling may be directly adjusted based not only on the number of current transactions (e.g., bandwidth being used) but also by available bandwidth at the operating frequency. Other operating parameters such as voltage and temperature may also be considered during preemptive transaction scaling.

In general, active (or dynamic) power consumption for a node may be expressed as being proportional to a number of parameters:

Active_Power∝C×V̂2×f×Activity_Factor (1)

where Active_Power represents a level of power consumption by the node; C represents capacitance associated with the wires and transistors of the node, which may include capacitance associated with all wires and transistors that may switch both in the node and at the transmission interfaces; V represents an operating parameter of a voltage at which the NoC is operating; f represents another operating parameter of a frequency at which the NoC is operating; and Activity_Factor represents an amount of activity in the node, which may range from no activity (Activity_Factor=0%) to full activity (Activity_Factor=100%). In one aspect of the disclosure, the term “activity” is associated with the transmission of transactions out of the node. By way of example and not limitation, operating conditions such as how much information is being (or will be) transferred, how many outbound transactions are (or will be) occurring, how many messages are being (or will be) sent, and/or how many packets are (or will be) transmitted may be considered. However, the term “activity” may also be associated with a variety of other operating conditions, such as how many wires and/or transistors are being (or will be) switched, where an Activity_Factor of 0% means no wires are being (or will be) switched while an Activity_Factor of 100% means all wires and/or transistors are being (or will be) switched. Thus, in general, the Activity_Factor may represent a percentage of: a total possible amount of information, messages, or packets that may be communicated by the node, and/or a total possible number of wires and/or transistors that may be switched by the node.

Various aspects of the disclosure for preemptive transaction scaling involve controlling the Activity_Factor of the node in view of the other parameters that affect the Active_Power such that determining an appropriate value for the Activity_Factor will reduce or eliminate occurrences of worst-case power viruses, and thereby, worse-case voltage droops. In other words, by determining an upper bound for the Activity_Factor in view of the other operating parameters, the Active_Power may be constrained to a maximum amount, where the maximum amount may be associated with a level at or under which the node may operate with little or no risk of a worst-case power virus occurring. For example, if the frequency (f) drops while all other operating parameters in Eq. 1, above, remain constant, the Activity_Factor may still be increased such that the product of the frequency and the Activity_Factor will result in the same level of Active_Power. In other words, as the frequency drops, the Activity_Factor may be increased in a commensurate amount. Similarly, as the frequency increases, the Activity_Factor may be decreased in a commensurate amount. Preemptive transaction scaling may also include a consideration of a current activity level of the node and how much change to that activity level will be caused by the scaling. For example, the preemptive transaction scaling may be adapted to slow the rate, such as in time, that the node may increase current consumption from very low levels up to higher levels.

It should be noted that information from one or more sensed inputs may also be used as factors affecting transaction scaling in various aspects of the disclosure for preemptive transaction scaling. For example, the present voltage level of the node as compared to a voltage set point may be used to determine transaction scaling. As another example, the operating temperature of the node, which may generally change at a slower rate of time as compared to other factors, will still have an overall impact on an overall peak sustainable current that may be achieved and thus impact on-die voltage relative to the set point voltage. Temperature, because it changes much more slowly, will generally not be involved in the magnitude of a rapid current change-induced voltage droop directly, but may indirectly be involved in that the margin left for the voltage droop may be modulated.

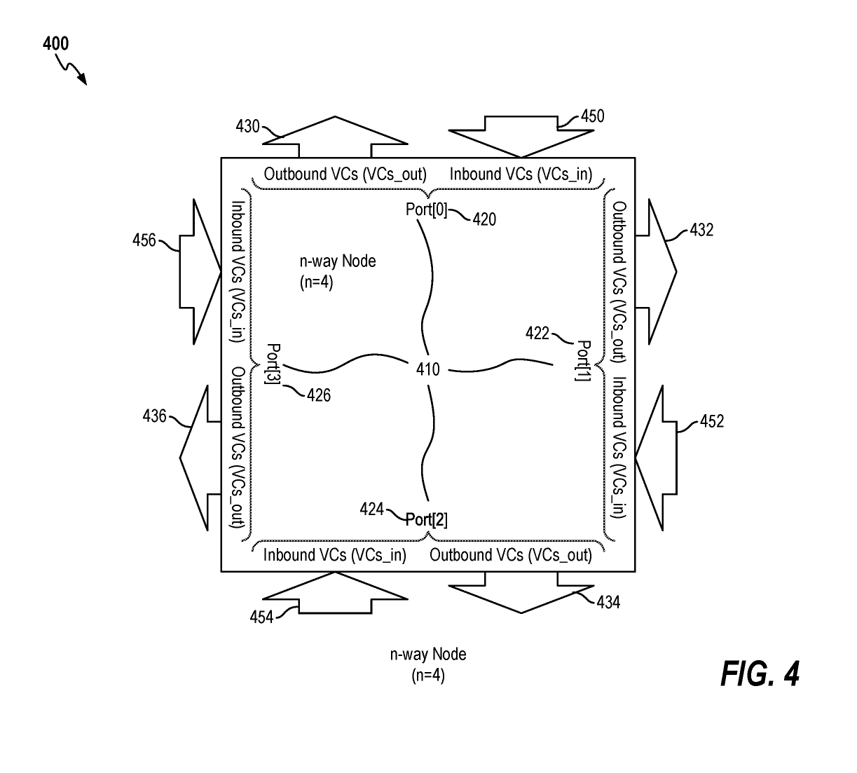

FIG. 4 illustrates a node 400 in which various aspects of preemptive transaction scaling disclosed herein may be implemented. The node 400 is an example of a 4-way node that includes a set of four ports 410, including a port[0] 420, a port[1] 422, a port[2] 424, and a port[3] 426. Each port in the set of four ports 410 includes a set of virtual channels. Each virtual channel is made up of an outbound virtual channel as well as an inbound virtual channel. Thus, the set of virtual channels of each port includes a set of outbound virtual channels and an associated set of inbound virtual channels. For example, the port[0] 420 includes a set of outbound virtual channels 430 and a set of inbound virtual channels 450; the port[1] 422 includes a set of outbound virtual channels 432 and a set of inbound virtual channels 452; the port[2] 424 includes a set of outbound virtual channels 434 and a set of inbound virtual channels 454; and the port[3] 426 includes a set of outbound virtual channels 436 and a set of inbound virtual channels 456.

As used herein, the term “virtual channel” is a logical construct that may refer to a physical interface through which communications may be effected by a node such as the node 400. Although generalities have been made herein for simplifying a description of one or more aspects of the disclosure, it should be understood that each virtual channel may include a different number of wires, and ports need not have a symmetrical number nor all types of virtual channels. In addition, one or more virtual channels (or one or more grouping of virtual channels) may carry different types of payloads. Different priorities may be assigned to the different types of payloads, which may also affect throttling operations of the preemptive transaction scaling aspects described herein.

Without loss of generality, when referencing one or more virtual channels (or inbound or outbound portions thereof) associated with one or more ports, the following notation will be used:

VC{_direction} {┌u┐} ┌v┐ (2)

where direction indicates whether the virtual channel is an inbound or outbound virtual channel, which will be omitted when the virtual channel as a whole (i.e., both the inbound and outbound portions of the virtual channel) is being referenced; u refers to a port u with which the virtual channel is associated, which will be omitted when the virtual channel in general (i.e., the particular virtual channel for all ports) is being referenced; and v refers to an index of the virtual channel An asterisk (“*”) may be used to indicate that all ports or virtual channels are being referenced. For example, virtual channel 0 for all ports may be identified as VC[0] or VC[*][0]; and VC_in[0] (or VC_in[*][0]) and VC_out[0] (or VC_out[*][0]) refers to the inbound and outbound portions, respectively, of virtual channel 0. As another example, virtual channel 0 of port 3 may be identified as VC[0][3]; and VC_in[0] and VC_out[0] refer to the inbound and outbound portions, respectively, of virtual channel 0 of port 3.

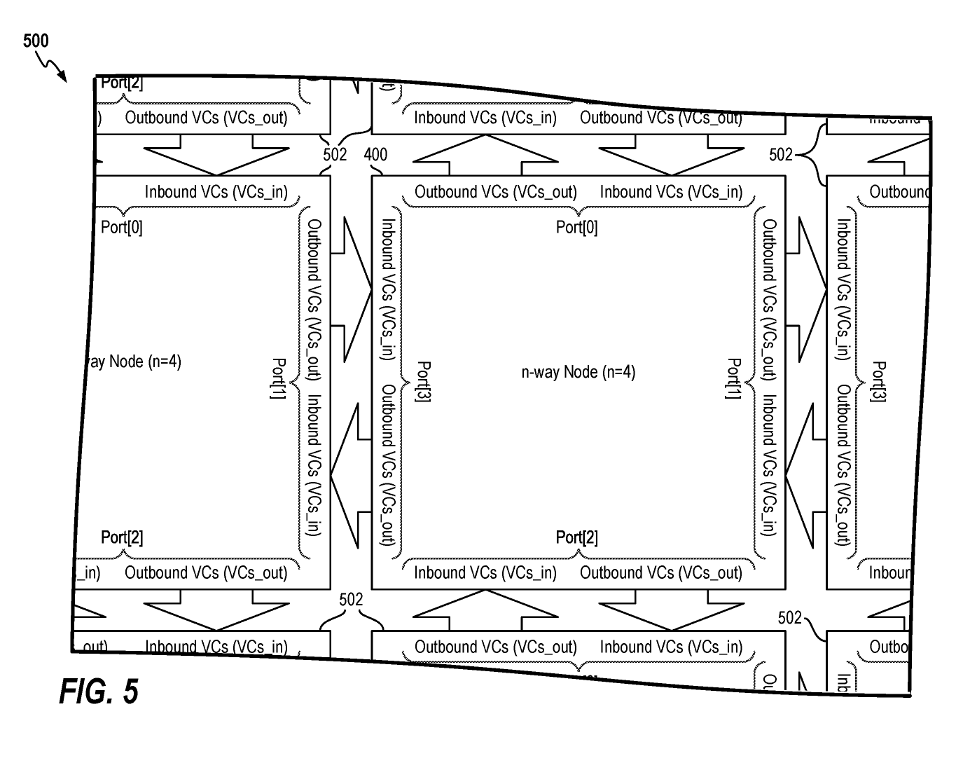

The node 400 may route communication between the four ports, such that inbound messages received on an inbound virtual channel for one port may be routed to an outbound virtual channel on another port. Each port may be coupled to another node or a device, but for the sake of not obfuscating the description, it will be assumed that each port in the node 400 is coupled to another node, as illustrated in FIG. 5, where the node 400 is coupled to a plurality of other nodes 502 to create a NoC in a mesh topology 500 for an SoC. In addition, although in some examples provided herein only one port in the node 400 may be detailed, the description for that one port may be applied to all other ports in that node. Moreover, to further simplify the description of various aspects of the disclosure contained herein, all ports shall be assumed to be identical in configuration unless otherwise noted. However, in implementation each port may be configured differently.

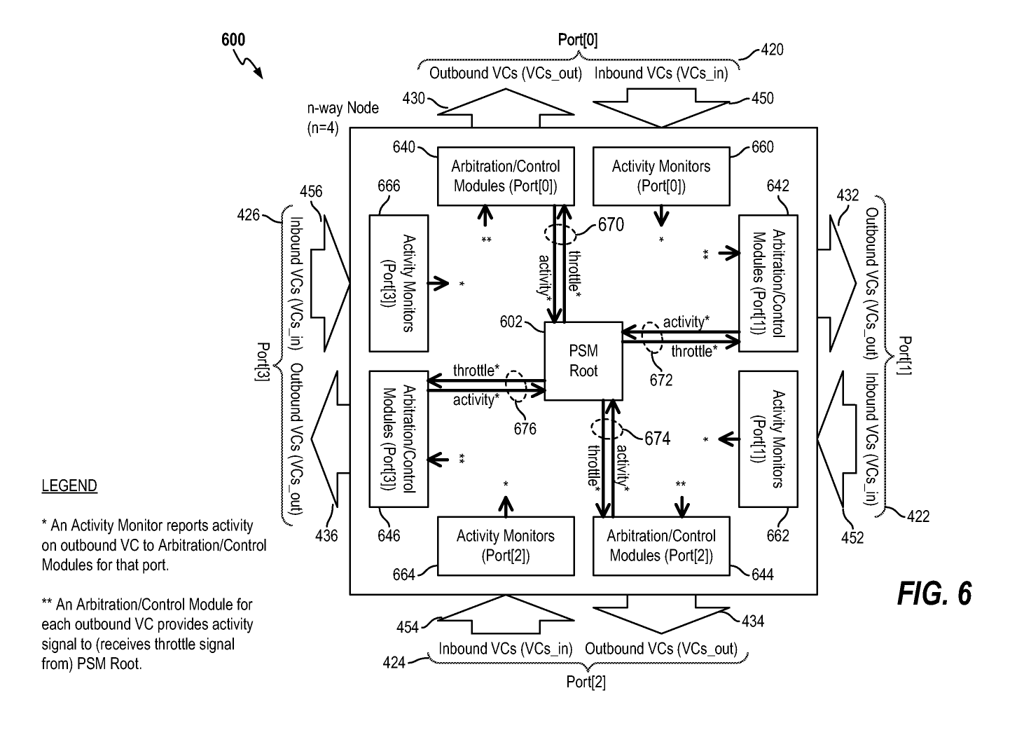

FIG. 6 illustrates a preemptive transaction scaling architecture 600 for a node configured in accordance with various aspects of the disclosure, such as node 400. The preemptive transaction scaling architecture 600 includes a preemptive scaling module (PSM) root 602 that is a processing system to determine any scaling that may be necessary for transactions communicated on the outbound virtual channels of the node 400. The preemptive transaction scaling architecture 600 also includes arbitration and control modules and activity monitors for each port in the set of four ports 410. For example, the port[0] 420 includes a set arbitration and control modules 640 and a set of activity monitors 660; the port[1] 422 includes a set arbitration and control modules 642 and a set of activity monitors 662; the port[2] 424 includes a set arbitration and control modules 644 and a set of activity monitors 664; and the port[3] 426 includes a set arbitration and control modules 646 and a set of activity monitors 666.

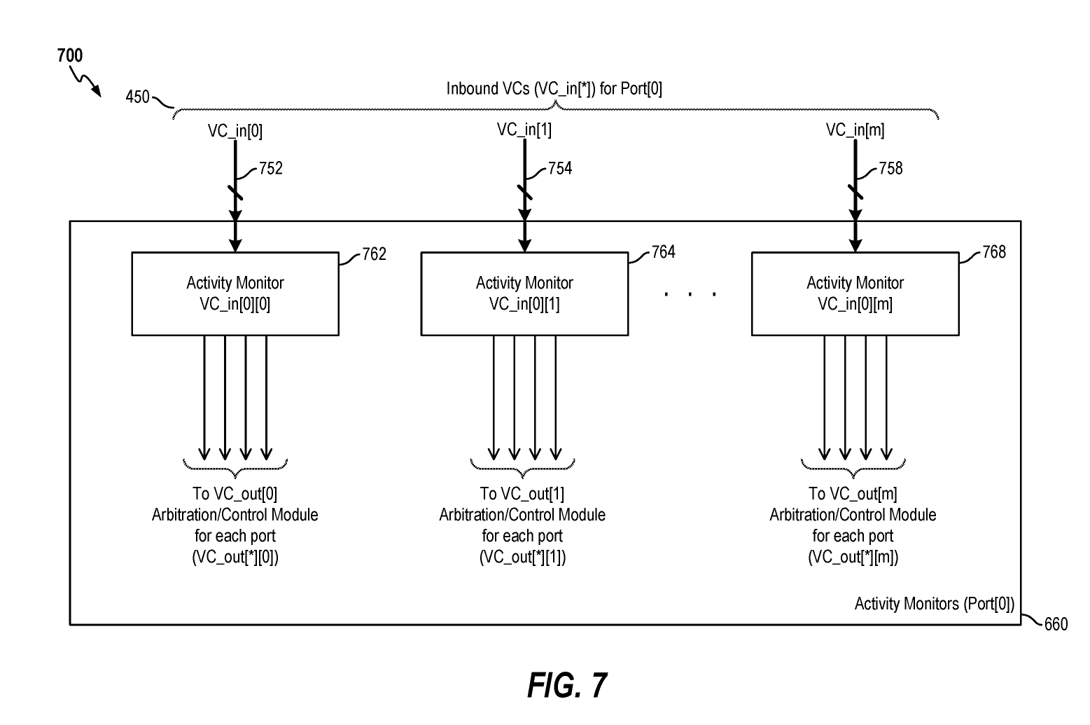

Each port in the set of ports 410 of the node 400 includes a set of activity monitors that may include an activity monitor associated with each virtual channel of that port to report on activity of that virtual channel FIG. 7 illustrates an example configuration with the port[0] 420, where the set of inbound virtual channels 450 for port[0] (VC_in[0][*]) includes an inbound virtual channel 0 (VC_in[0]) 752, and an inbound virtual channel 1 (VC_in[1]) 754 through an inbound virtual channel m (VC_in[m]) 758, where m may represent any positive integer. The set of activity monitors 660 for the port[0] 420 includes an activity monitor VC_in[0][0] 762 for the VC_in[0] 752; and an activity monitor VC_in[0][1] 764 for the VC_in[1] 754 through an activity monitor VC_in[0][m] 768 for the VC_in[m] 758. In one aspect of the disclosure, each activity monitor may report on the activity on an inbound virtual channel to all arbitration and control modules associated with an outbound virtual channel of the same virtual channel These activities may be aggregated across virtual channels in order to guide overall transaction limiting, as further described herein. For example, the activity monitor VC_in[0][0] 762 reports any activity on the VC_in[0] 752 to all arbitration and control modules for VC_out[0] of each port (VC_out[*][0]).

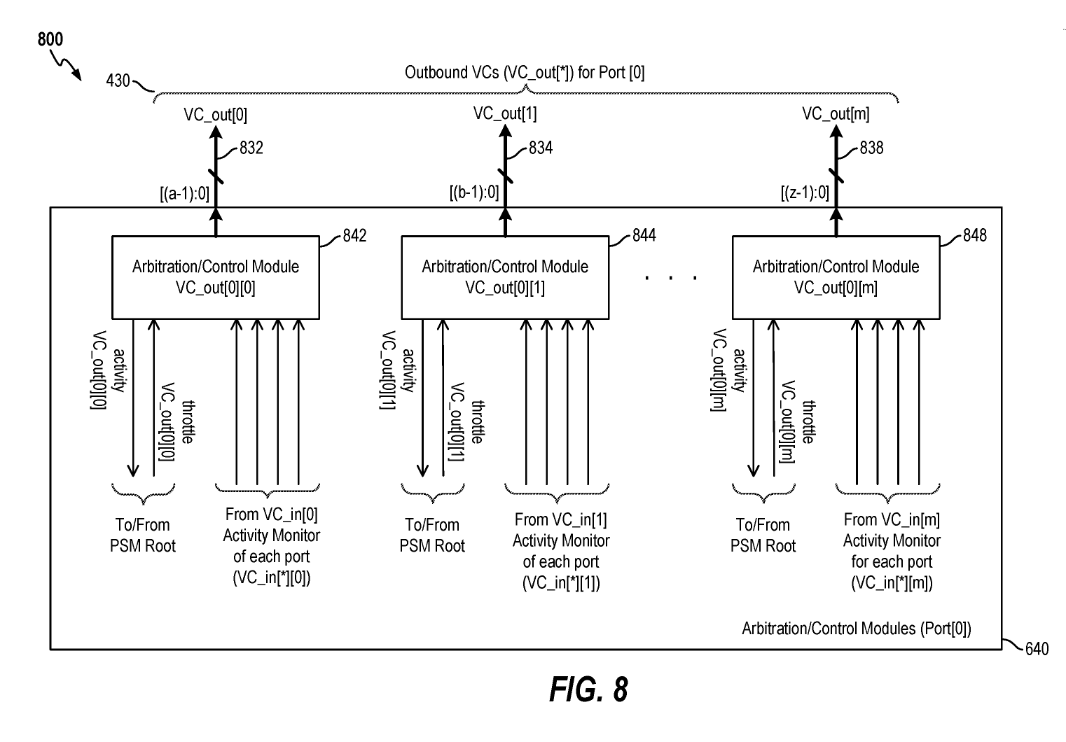

Referring to FIG. 8 while also still referring to FIG. 6 generally and the example of FIG. 4 specifically, the port[0] 420 includes a set of outbound virtual channels 830 with an outbound virtual channel 0 (VC_out[0]) 832, and an outbound virtual channel 1 (VC_out[1]) 834 through an outbound virtual channel m (VC_out[m]) 838. Each outbound virtual channel includes a number of wires over which communication is sent by switching between signal levels (e.g., low-to-high or high-to-low). For example, the VC_out[0] 832 includes a number “a” of wires ([(a-1):0]), the VC_out[1] 834 includes a number “b” of wires ([(b-1):0]), and the VC_out[m] 838 includes a number “z” of wires ([(z-1):0]), where a, b, and c may be any positive integers. Each virtual channel may have a different number of wires associated therewith, although, without loss of generality, it will be assumed that the same virtual channel of all ports will have the same number of wires.

In one aspect of the disclosure, each set of arbitration and control modules of a port in the preemptive transaction scaling architecture 600 may include an arbitration and control module associated with a virtual channel of that port. Specifically, there may be an arbitration and control module associated with each outbound virtual channel Thus, the set of arbitration and control modules 640 for port[0] includes an arbitration and control module VC_out[0][0] 842 associated with the VC_out[0] 832; and an arbitration and control module VC_out[0][1] 844 through an arbitration and control module VC_out[0][m] 848 associated with the VC_out[1] 834 through the VC_out[m] 838, respectively.

Each arbitration and control module that is associated with a particular outbound virtual channel for a particular port may aggregate activity information reported by all activity monitors associated with the same inbound virtual channel on all ports, and then provides an activity signal to the PSM root 602. The PSM root 602 may use the received activity information and other considerations to determine whether to scale transactions on a particular virtual channel, as further discussed herein. The PSM root 602 may provide a throttle signal to an arbitration and control module to throttle transactions of an associated outbound virtual channel In one aspect of the disclosure, an arbitration and control module may throttle any transactions on an outbound virtual channel by preventing switching of any wires associated with that virtual channel.

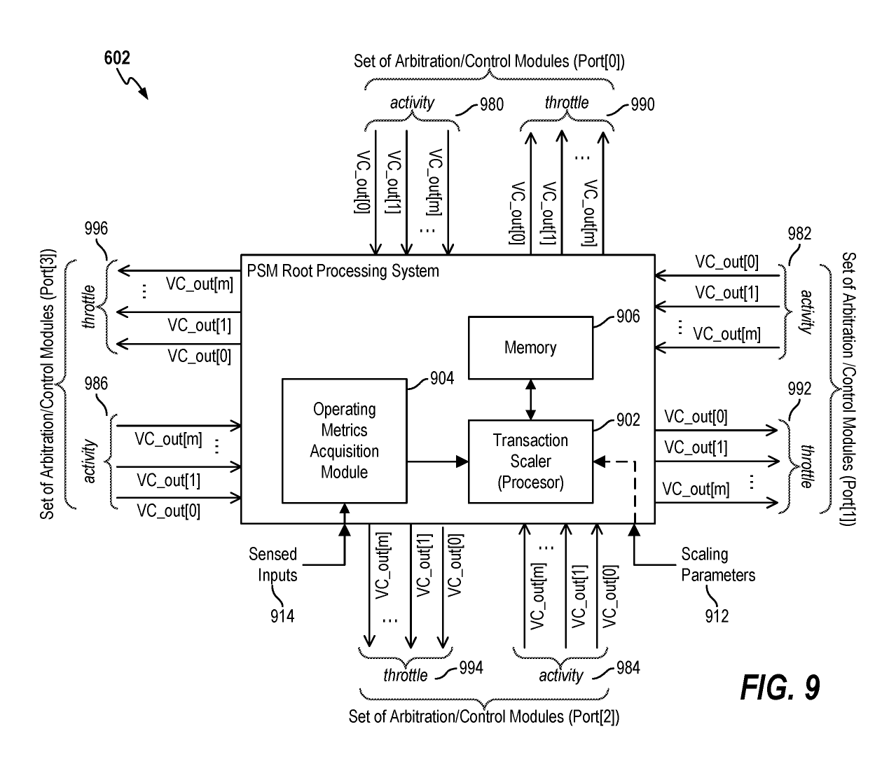

FIG. 9 provides details for the PSM root 602, which includes a transaction scaler 902 that determines whether throttling is necessary based on such inputs as scaling parameters 912 and operating metrics information such as information about the node 402, other nodes such as the nodes 502, or the NoC in general, as further detailed herein. An operating metrics acquisition module 904, which may also be referred to as a metrics monitor, may acquire the operating metrics information from a variety of sources, including sensed inputs 914. The operating metrics information and the scaling parameters 912 may be stored in a memory 906 that may also store operating metrics information for previous cycles. The transaction scaler 902 may also receive a set of activity signals from, and provides a set of throttle signals to, all arbitration and control modules of each port (to avoid overcomplicating FIG. 9, the paths connecting the transaction scaler 902 to the set of activity signals and the set of throttle signals have been omitted). Specifically, the transaction scaler 902 receives a set of activity signals 980 from, and provides a set of throttle signals 990 to, a set of arbitration and control modules for port[0], such as the set of arbitration and control modules 640 of FIG. 6. The transaction scaler 902 also receives a set of activity signals 982, a set of activity signals 984, and a set of activity signals 986 from a respective set of arbitration and control modules for port[1], port[2], and port[3]. The transaction scaler 902 further provides a set of throttle signals 992, a set of throttle signals 994, and a set of throttle signals 996 to the respective set of arbitration and control modules for port[1], port[2], and port[3].

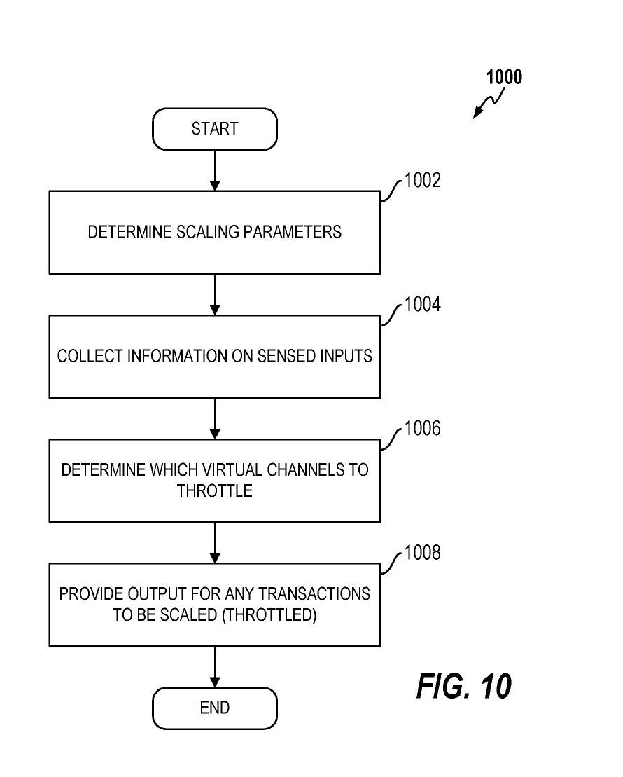

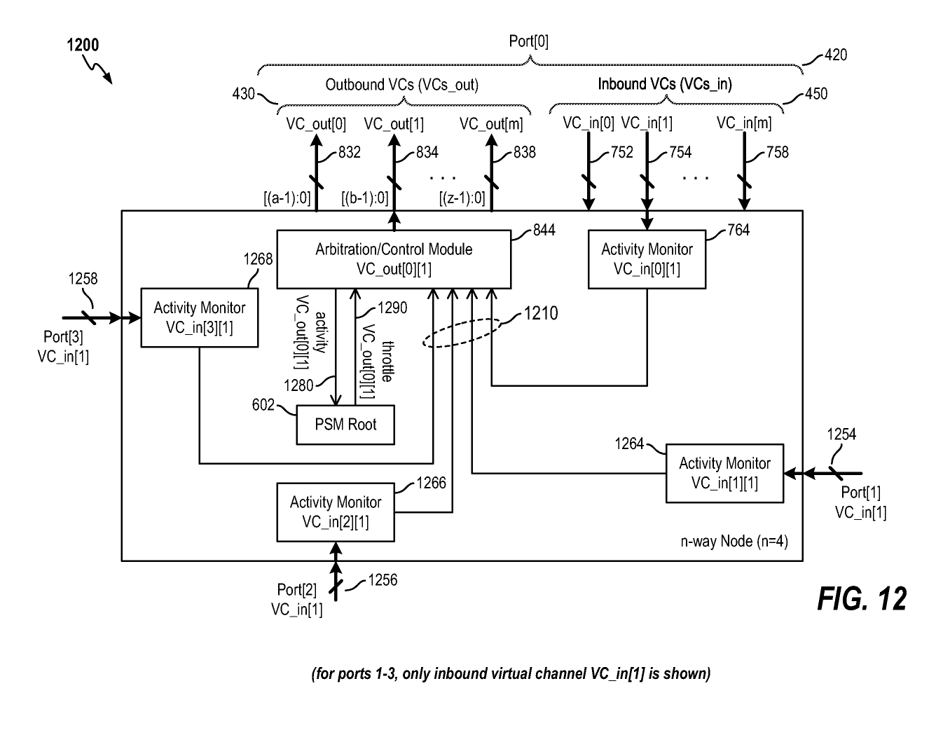

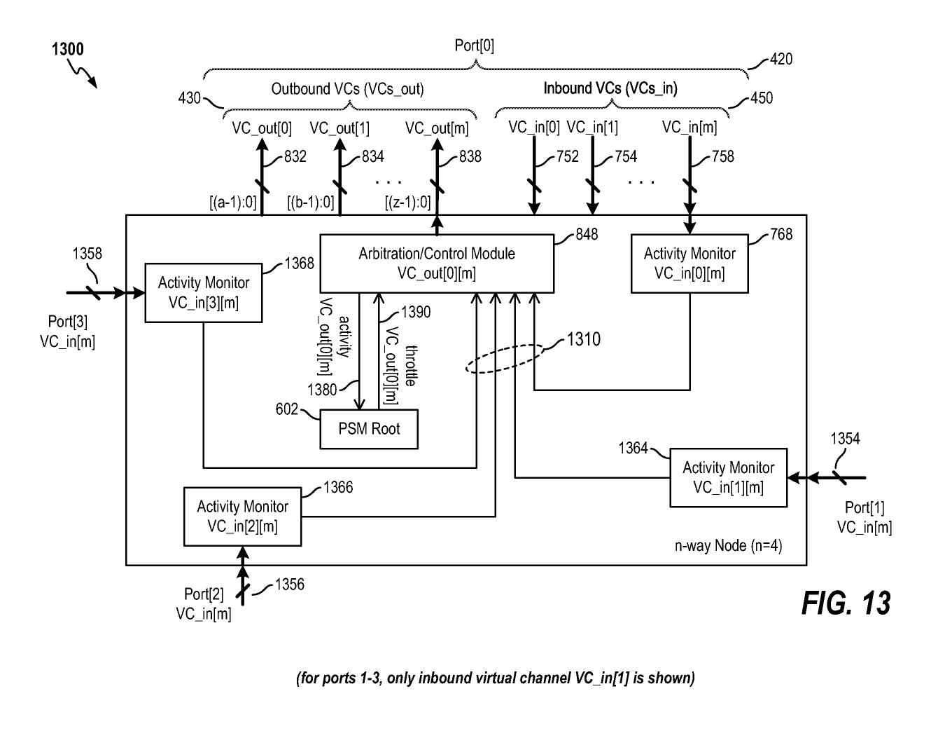

FIG. 10 illustrates a preemptive transaction scaling process 1000 configured in accordance with various aspects of the disclosure that may be used by the transaction scaler 902. The description of FIG. 10 will also reference FIG. 12, which provides an example of the preemptive transaction scaling architecture 600 as applied to a configuration for throttling the wires of the VC_out[0] 832 of the port [0] 420; and FIG. 13, which provides an example of the preemptive transaction scaling architecture 600 as applied to a configuration for throttling the wires of the VC_out[m] 838 of the port[0] 420.

At 1002, the transaction scaler 902 may determine various scaling parameters, such as the scaling parameters 912, that may be considered during the operation of the remaining portion of the preemptive transaction scaling process 1000. Granularity of scaling parameters that may be considered may range from a node-level down to a single virtual channel. An example of a scaling parameter at the node-level include a predetermined limit for the Active_Factor of the node 400. Thus, as described below, the transaction scaler 902 may consider how scaling of each virtual channel may affect the predetermined limit. Specifically, the transaction scaler 902 may consider throttling a virtual channel if, by not doing so, the predetermined limit will be exceeded. Examples of scaling parameters at the virtual channel level, which should not be considered limiting, include a weight that may be assigned based on a number of wires in the virtual channel, or a priority level that may be assigned to the virtual channel For example, any virtual channels for transferring data may be assigned a higher priority than other virtual channels. It should be noted that certain scaling parameters, such as the number of wires in a particular virtual channel, may be static throughout all operations of the preemptive transaction scaling process 1000 and thus only need to be determined once at 1002, whereas other scaling parameters, such as the predetermined limit for the Active_Factor, may be variable and thus need to be determined at various times. For example, as noted above and as further described herein, because Active_Power is affected by other variables such as the operating frequency and voltage, a predetermined limit for the Active_Factor may change based on a specific operating frequency and/or voltage at which the node 400 is operating. For example, when the NoC is operating at low frequency and voltage points, a maximum level of current consumption will be significantly reduced even if every wire switches. In other words, the worst-case current consumption will be low enough such that occurrence of a voltage droop that would cause a failure will be unlikely. In this case, all channels may remain unblocked and freely send messages as needed. Thus, transaction limiting may be relaxed or removed based on mesh mode clock frequency, voltage, and/or any voltage and dynamic clock and voltage scaling (DCVS) events. Multiple levels of transaction blocking, such as that expressed as predetermined limits for the Active_Factor, may be stored in the memory 906 so that the transaction scaler 902 may switch between these levels based on scaling parameters. Once the various scaling parameters have been determined, operation continues with 1004.

At 1004, the transaction scaler 902 may receive information from the operating metrics acquisitions module 904 such as the operating metrics information that includes one or more sensed inputs. Examples of sensed input information, which should not be considered limiting, include aggregate VC[*] activity per port, adjacent node clock-gating, operating frequency and/or voltage of the node 400, and other relevant indicators for determining power consumption. For example, each arbitration and control module may aggregate activity information for all inbound virtual channels associated with the outbound virtual channel from all ports. The aggregated activity information is then provided to a PSM root such as the PSM root 602. Referring to FIG. 12, the arbitration and control module (VC_out[0][1]) 844 for the VC_out[1] 834 may receive reported activity from an activity monitor (VC_in[0][1]) 764 for the VC_in[1] 754 of port[0], an activity monitor (VC_in[1][1]) 1264 for the VC_in[1] 1254 of port[1], an activity monitor (VC_in[1][1]) 1266 for the VC_in[1] 1256 of port[2], and an activity monitor (VC_in[1][1]) 1268 for the VC_in[1] 1258 of port [3]. The arbitration and control module (VC_out[0][1]) 844 may then aggregate the information and provide it to the PSM root 602 in an VC_out[0][1] activity signal 1280. Similarly, referring to FIG. 13, the arbitration and control module (VC_out[0][m]) 848 for the VC_out[m] 838 may receive reported activity from an activity monitor (VC_in[0][m]) 768 for the VC_in[m] 758 of port[0], an activity monitor (VC_in[1][m]) 1364 for the VC_in[m] 1354 of port[1], an activity monitor (VC_in[1][m]) 1366 for the VC_in[m] 1356 of port[2], and an activity monitor (VC_in[1][m]) 1368 for the VC_in[m] 1358 of port [3]. The arbitration and control module (VC_out[0][m]) 848 may then aggregate the information and provide it to the PSM root 602 in an VC_out[0][m] activity signal 1380.

As discussed earlier, the transaction scaler 902 may store any collected information as well as track other metrics for use in future throttling determination operations in the memory 906. Thus, historical information such as a number of transactions not throttled in one or more previous transactions may be determined such that the information available to determine whether throttling is desired includes not only operating metrics for the current or an upcoming cycle (present or future sensed input information), but also for a previous cycle (historic sensed input information). Once the transaction scaler 902 has collected the information, operation continues with 1006.

At 1006, the transaction scaler 902 may determine which virtual channels to throttle. In one aspect of the disclosure, the throttling of one or more virtual channels may be for one-to-p upcoming cycles, where p may be a small, single-digit integer. The transaction scaler 902 may minimize impact to the performance of the node 400, and therefore minimize impact to the performance of the NoC in general, by minimizing the time (i.e., the number of cycles) that any throttling is imposed. For the description of the preemptive transaction scaling process 1000 as applied to the examples provided herein, unless otherwise noted each throttling decision only applies for the next cycle. Thus, a determination of which virtual channels may be throttled will change from cycle-to-cycle, with the default being no throttling.

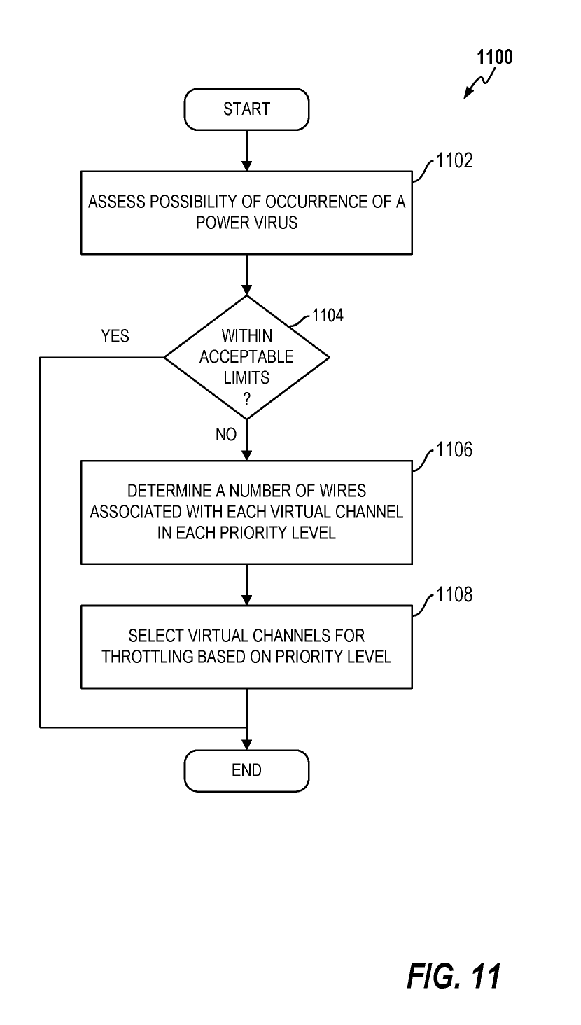

Various approaches may be taken to determine which virtual channels may be throttled by the transaction scaler 902 to achieve an acceptable level of Activity_Factor in the next cycle and thus enforce a limit of a maximum number of wires that may be switched. FIG. 11 illustrates one example of a virtual channel throttling determination process 1100 where the transaction scaler 902, at 1102, may assess a possibility of an occurrence of a power virus (i.e., severe rapid current change event) based on the information collected for the one or more sensed inputs. In general, the number of virtual channels affected in any cycle may be modulated, in real time, based on actual operating conditions and actual workloads that are being observed.

In one aspect of the disclosure, the transaction scaler 902 may assess the possibility by determining a level for Active_Power based on a number of wires that switches at the current operating frequency and voltage. For example, wires of outbound virtual channels may be put through XOR operations using logic gates to determine how many wires have actually switched. Future transactions may then be limited. Thus, a number of throttled virtual channels in any cycle may be adjusted in real time based on actual need. As discussed, the operating metrics acquisition manual 904 may provide detection of frequency information or voltage and dynamic clock and voltage scaling (DCVS) events. By locally observing the frequency and/or voltage of the mesh, the number of virtual channels throttled in any cycle may be modulated dynamically. Thus, any penalty to performance that may be suffered from potentially blocked messages will only occur at high frequency and high voltage points where the virus current potential is very high. A tradeoff may be made between performance penalties and potential for failure due to virus current. In general, in various other aspects, transactions may be limited by the transaction scaler 902 based on current consumption regardless of what voltage and/or frequency at which the node is operating.

In another aspect of the disclosure, how many packets are being transmitted is examined such that a number of packets that may be sent out of the node 402 may be constrained to ensure that only a certain number of wires are switched. Various aspects of the disclosure for preemptive transaction scaling may be applied to scaling based on how many wires that may need to be driven by a particular transaction versus what is being communicated by the transaction. For example, assuming only one wire will be allowed to toggle in an upcoming transaction, if a current transaction has the pattern <101>, then any transaction with a pattern that will require more than one wire being toggled will be blocked. Table 1 provides transaction patterns that will be allowed or blocked based on this example.

TABLE 1
Example of Allowed/Limited Transactions
Based on No. of Wires to be Switched

| Upcoming | No. of Wires | |
|---|---|---|
| Transaction Pattern | to be Toggled | Allowed/Limited |
| 000 | 2 | Limited |
| 001 | 1 | Allowed |
| 010 | 3 | Limited |
| 011 | 2 | Limited |
| 100 | 1 | Allowed |
| 101 | 0 | Allowed |
| 110 | 2 | Limited |
| 111 | 1 | Allowed |

Various other aspects of the disclosure for preemptive transaction scaling may be applied to scaling without actually examining the individual wires as described above. In these other aspects, scaling may be based on an assumption of any number of wires in a VC that could toggle and thus limit the number of outbound VCs that actually can toggle by blocking a particular VC (or set of VCs) in a particular cycle. As noted above, any transactions that are blocked, limited, or scaled as described herein are not actually lost, but should be considered to be delayed and may be sent in one or more future cycles.

In yet another aspect of the disclosure, as part of the assessment the transaction scaler 902 may consider statistical or historical information such as one or more previous cycles in which no throttling occurred. Thus, the transaction scaler 902 may “take credit” for recent activity, or lack thereof specifically, to reduce a likelihood of throttling of any virtual channels. For example, where an interface for a particular direction had no transactions to be sent in a previous cycle (or within the previous n-cycles where, again, n being a small, single-digit number), the node may consider some or all of those transactions to be credited against the number of transactions that would be blocked in an upcoming cycle (or in future p-cycles where, again, p may be a small, single-digit number). It should be noted that the values of n and p may be the same or different from each other. Thus, in certain instances, no transactions may ultimately be blocked based on consideration of current and historical information.

In general, one or more schemes may be used to limit transactions, and each specific implementation may balance the time required to observe and count transactions and the time needed to block future transactions. Additional mechanisms within a node such as the node 402 may be employed to make throttling decisions based on operating history of the node over a small number of cycles. These mechanisms may be needed where the node is large enough such that sending messages to different receivers (directions) may not be able to be centralized, processed, and responses generated in a single cycle. However, a small number of cycles that may be needed to determine throttling, relative to the voltage droop response time constant of the PDN may be allowable. The number of transactions actually blocked may be minimized, which takes full advantage of cases where transactions on some channels were not needed at all. Once the possibility of the occurrence has been determined, operation continues with 1104.

At 1104, the transaction scaler 902 may determine if the possibility of the occurrence of a power virus assessed at 1102 is within an acceptable limit. In one aspect of the disclosure, the determination may be based on whether a limit for the Activity_Factor for the node 400 will be exceeded. If the possibility a power virus occurring is within an acceptable limit, then the virtual channel throttling determination process 1100 ends. Otherwise, operation continues with 1106.

At 1106, determines a number of wires associated with each level of priority of virtual channels. In one aspect of the disclosure, this may be determined by first identifying how many wires are associated with each virtual channel. Where the number of wires associated with each virtual channel is static and the priority level assignment for each virtual channel is unchanged, the determination at 116 may only need to be performed once.

At 1108, one or more virtual channels may be selected based on priority, which includes how many wires are to be toggled by each of the virtual channels being considered for throttling. For example, virtual channels with the lowest priority will be selected for throttling first, then the virtual channels with the next lowest priority will be selected for throttling, etc., until a total number of wires that will be blocked from being switched results in an acceptable level of Activity_Factor. Although the examples herein provide that all the wires of an outbound virtual channel being throttled may be blocked from switching, in other configurations various levels of scaling granularity may be implemented.

Constraint of transactions destined for each adjacent node may be based on considerations of fairness and overall performance For example, if some or all of the transactions for a particular adjacent node were blocked in a particular cycle because of a transaction limiting constraint (i.e., the total number of wires that may be switched needed to be limited) and the same transaction limiting constraints remained for the next cycle (i.e., the total number of wires that may be switched in the next cycle still needs to be limited), some or all transactions for a different adjacent node may be throttled while the previously throttled transactions for the same adjacent node may now be allowed.

Once the transaction scaler 902 has determined at 1006 which, if any, virtual channels need to be throttled, operation may continue to 1008, where the PSM root 602 may provide output for scaling transactions such as by providing throttle signals to any arbitration and control modules associated with virtual channels that are to be throttled. An arbitration and control module receiving a throttle signal may then block the wires for the associated outbound virtual channel from switching. Referring again to FIG. 12, the arbitration and control module (VC_out[0][1]) 844 may receive a VC_out[0][1] throttle signal 1290 from the PSM root 602. Similarly, referring again to FIG. 13, the arbitration and control module (VC_out[0][m]) 848 may receive a VC_out[0][m] throttle signal 1390 from the PSM root 602.

As discussed above, adjacent node clock-gating information may be used by a particular node such as the node 402 to determine if certain adjacent nodes 502 are not active, thereby reducing potential need to limit transactions by taking into account the power being saved by any inactivity, including transactions that are not being transmitted to those adjacent nodes. Thus, the potential need to limit transactions may take into account not only power not being used by the node 402 to communicate with an inactive interface of an adjacent node 502, it may also include consideration of the power not being used by the inactive interface in adjacent node 502. Moreover, if the adjacent node 502 is completely idle (e.g., there is no data movement in that node 502), then the potential need to limit transactions by the node 402 may further be reduced by also taking into account the power saved from the adjacent node 502 being idle. Viewed from another perspective, each active node neighboring an idle node may claim a portion of the power saved by that node being idle.

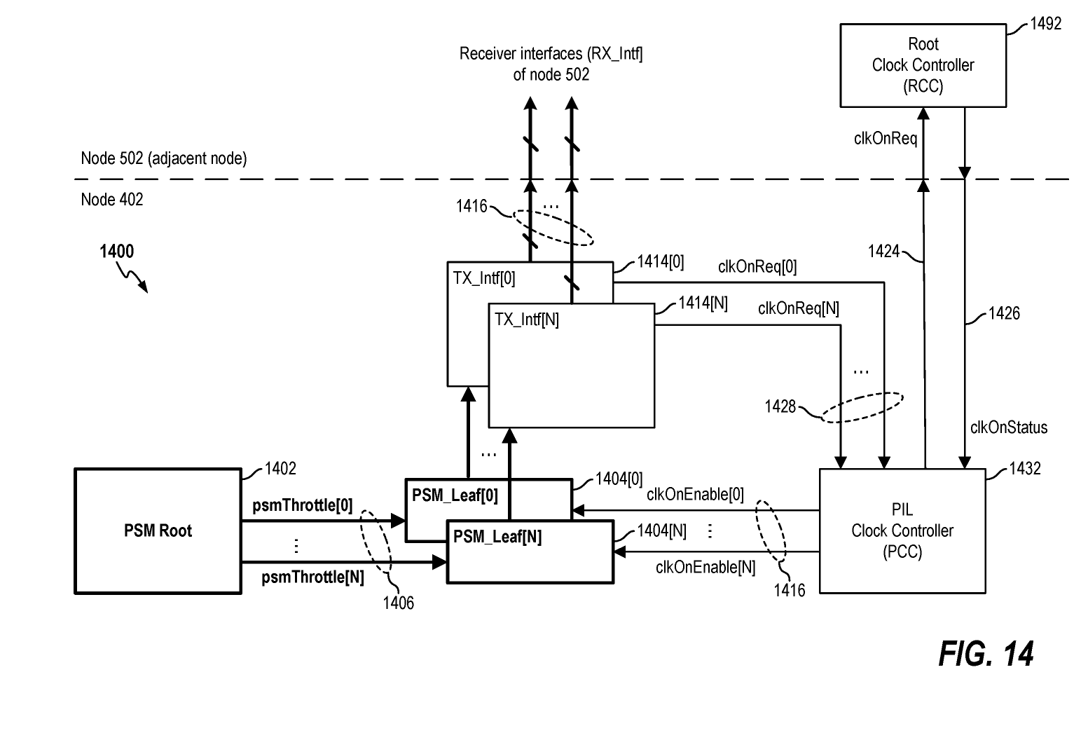

FIG. 14 illustrates a preemptive transaction scaling scheme 1400 configured in accordance with various aspects of the disclosure for preemptive transaction scaling in a node such as the node 402 that may consider clock-gating information of an adjacent node such as one of the adjacent nodes 502. To avoid obfuscating the description of the preemptive transaction scaling scheme 1400, only the outbound portion of a single port is illustrated. The port includes a number “i” of transmission interfaces (TX_Intf[i]), where “i” may be from 0 to N (a TX_Intf[0] 1414[0] to a TX_Intf[N] 1414[N]), each of which provides switching of an associated number of wires in a set of outbound wires 1416 to send messages to the adjacent node 502. In the provided examples, references may be made to “transmission interfaces” as opposed to “virtual channels.” However, all described aspects provided throughout this document for preemptive scaling (or limiting) of transactions on virtual channels should be understood to apply to the transmission interfaces in the preemptive transaction scaling scheme 1400, unless otherwise noted.

A PIL clock controller (PCC) 1432 provides clocking for all interfaces, and in embodiments where interfaces are grouped, a separate PCC may be used to provide clocking for each group of interfaces. Typically, a PCC may enable/disable operation of each interface by clock-gating through use of a set of clock enable (clkOnEnable) signals 1416 (clkOnEnable[0] to clkOnEnable[N]), the provision of which may be based on a request signal in a set of clock request (clkOnReq) signals 1428 sent from a respective interface. In one aspect of the disclosure, the preemptive transaction scaling scheme 1400 is complementary to existing clock-gating mechanisms and may leverage these mechanisms for limiting transactions. Specifically, in FIG. 14 throttling of each interface is performed by an associated control module referred to as a leaf (PSM_Leaf) that controls whether the clkOnEnable signal may be received by the interface. For example, a PSM_Leaf[0] 1404[0] is associated with the TX_Intf[0] 1414[0] and a PSM_Leaf[N] 1404[N] is associated with the TX_Intf[N] 1414[N]. Each leaf intercepts a clkOnEnable signal in the set of clkOnEnable signals 1416 that normally would be provided to an associated interface. For example, the PSM_Leaf[0] 1404[0] may receive the clkOnEnable[0] signal that normally would be coupled directed to the TX_Intf[0] 1414[0] and the PSM_Leaf[N] 1404[N] may receive the clkOnEnable[N] signal that normally would be coupled directed to the TX_Intf[N] 1414[N].

A PSM root 1402 generates throttling signals for every leaf instance in the node to notify when a leaf instance should throttle, which may use gating signals to disable switching of a number of wires in a particular interface. As illustrated, each PSM_Leaf receives a throttle signal from a set of throttle (psmThrottle) signals 1406 (psmThrottle[0] to psmThrottle[N]) that is generated by the PSM root 1402. Based on the throttle signal, a leaf instance may or may not provide the clkOnEnable signal to its associated interface. For example, if the PSM_Leaf 1404[0] receives the psmThrottle[0] signal from the PSM root 1402, then the PSM_Leaf 1404[0] may block the clkOnEnable[0] signal for the TX_Intf[0] 1414[0]. In accordance with various aspects of the disclosure, the PSM root 1402 operates in a manner similar to the PSM root 602, with further details described herein. Thus, in addition to the throttling interfaces based on adjacent node clock-gating information, the PSM root 1402 may operate to throttle interfaces based on various other factors and information.

In one aspect of the disclosure, the PSM root 1402 may throttle transactions by using leaf instances for safely overloading transmitter and clock gate/enable signals. Many leaf instances within the node are distributed such that each leaf is physically located near a respective transmitter interface for which it controls limiting. Because of the relative large size of the node, the interfaces for each adjacent node are located at great distances away from each other. Thus, notification to throttle to a particular leaf may be distributed so that the leaf may handle the throttling in the next cycle (or p-cycles). The preemptive transaction scaling scheme 1400 provides a complementary scheme that leverages existing mechanisms for preventing transactions to implement transaction limiting (e.g., clock gating mechanisms that already exist in the node 602 may be used to block transactions). Unlike approaches that encode/decode transactions, the preemptive transaction scaling scheme 1400 has lower overhead because this scheme does not introduce delays such as encode/decode operations into critical paths.

In another aspect of the disclosure, signaling from an adjacent node in the NoC that indicate a status in that particular node may be used to infer that it may not be necessary to switch any outbound wires to that adjacent node in a particular cycle. One signaling example as noted above is adjacent node clock-gating signaling where, if an adjacent node is presently clock-gated, it will need to be woken up by the node before messages can be transmitted—even if there is a desire to send the message in a particular cycle. Continuing to refer to FIG. 14, a root clock controller (RCC) 1492 of the adjacent node 502 may provide information to the PCC 1432 of the node 402 using a clock enable status (clkOnStatus) signal 1426 about whether the adjacent node 502 is active. The PCC 1432 may activate the adjacent node 502 by sending a request (clkOnReq) signal to the RCC 1492 to wake the adjacent node 502. While waiting for the adjacent node 502 to activate, outbound wires to other nodes in the node 402 may be fully used because the PSM root 1402 knows a priori that the outbound wires to the clock-gated node (i.e., the set of outbound wires 1416 to the adjacent node 502) will not be switched. Thus, in the example configuration of FIG. 5, where the node 402 is coupled to four (4) of the adjacent nodes 502, if one of these adjacent nodes is clock-gated, the node 402 may be able to send transactions to the other three adjacent nodes without blocking based on a worst-case Activity_Factor of 75%. In other words, because no wires in the port[0] 420 that is coupled to the clock-gated adjacent node will be switched, the node 402 may be able to toggle all the wires in the ports coupled to the other three adjacent nodes (i.e., the port[1] 422, the port[2] 424, and the port[3] 426) because at most only three quarters of all the outbound wires of the node 402 will be switched.

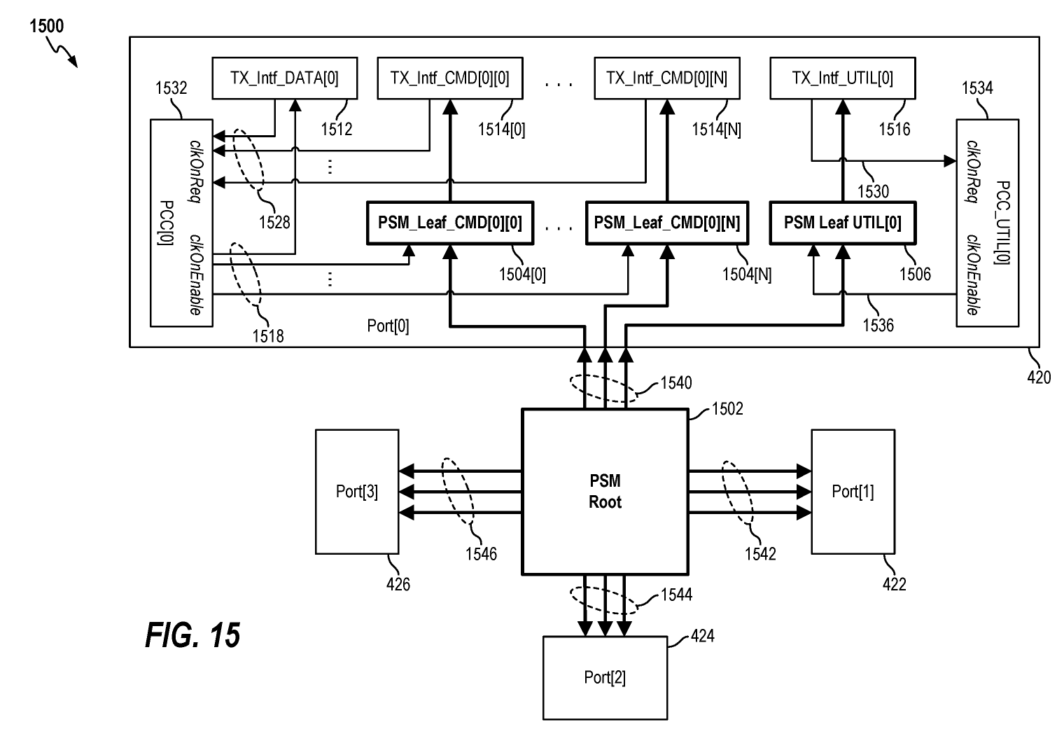

FIG. 15 illustrates a preemptive scaling architecture 1500 configured in accordance with the preemptive scaling scheme 1400 of FIG. 14, as used in a node such as the node 402. The preemptive scaling architecture 1500 operates with the port[0] 420, the port[1] 422, the port[2] 424, and the port[3] 426. In the illustrated configuration, the port[0] 420 includes a data transmission interface (TX_Intf_DATA[0]) 1512; a set of CMD transmission interfaces (TX_Intf_CMD[0][i]) 1514[i], where i ranges from 0 to N, where N is a positive integer; and a UTIL transmission interface (TX_Intf_UTIL[0]) 1516.

The preemptive scaling architecture 1500 also includes a PCC for the data and command transmission interfaces, and a separate PCC for the utility command transmission interface. Specifically, a PCC[0] 1532 is used as the PIL clock controller for the TX_Intf_DATA[0] 1512 and the TX_Intf_CMD[0][i] 1514[i], and a PCC_UTIL[0] 1534 is used as the PIL clock controller for the TX_Intf_UTIL[0] 1516. The PCC[0] 1532 provides a set of clock enable (clkOnEnable) signals 1518 that includes clock enable signals for the TX_Intf_CMD[0][i] 1514[i]. In one aspect of the disclosure, the clock enable signals for the TX_Intf_CMD[0][i] 1514[i] is sent to a respective leaf for the command transmission interfaces (PSM_Leaf_CMD[0][i]) 1504[i], where i ranges from 0 to N, N being a positive integer. Similarly, the PCC_UTIL[0] 1534 provides a clock enable (clkOnEnable) signal 1536 to a leaf (PSM Leaf UTIL[0]) 1506 associated with the TX_Intf_UTIL[0] 1516. As discussed above, each leaf is responsible for throttling transactions on a transmission interface associated therewith, as controlled by a PSM root 1502. In this configuration, there is no throttling of data transmissions to ensure performance on this type of transaction is not affected. Thus, the clock enable signals from the PCC[0] 1532 is coupled directly to the TX_Intf_DATA[0] 1512.

The PCC[0] 1532 receives a set of clock enable request (clkOnReq) signals 1528 from the TX_Intf_DATA[0] 1512 and the TX_Intf_CMD[0][i] 1514[i]. The PCC_UTIL[0] 1534 also receives a clock enable request (clkOnReq) signal 1530.

The PSM root 1502 provides a set of throttle signals 1540 for the port[0] 420, a set of throttle signals 1542 for the port[1] 422, a set of throttle signals 1544 for the port[2] 424, and a set of throttle signals 1546 for the port[3] 426. In accordance with various aspects of the disclosure, the PSM root 1502 may operate in a similar fashion to the PSM root 602, which is also as discussed for the PSM root 1402.

In one configuration, the apparatus for minimizing power virus in a network on chip includes means for comparing, with at least one threshold, an operational metric related to a node configured to manage communication of a first number of outbound transactions; means for determining, based on the comparison, a second number of outbound transactions from the first number of outbound transactions that are allowed from the node; and a set of transmission interfaces configured to communicate the second number of outbound transactions. In one aspect of the disclosure, the aforementioned means may be the processing system of the PSM root 602 disclosed in FIG. 6, including the transaction scaler 902, and the PSM root 1402 of FIG. 14, and the PSM root 15 of the FIG. 15. The processing system may be configured to perform the functions recited by the aforementioned means. In another aspect of the disclosure, the aforementioned means may be a module or any apparatus configured to perform the functions recited by the aforementioned means. For example, the apparatus for minimizing power virus in a network on chip may include means for collecting information for, and storing the operational metric, which means may be the operating metrics acquisition module 904.

Conceptually, prior art approaches that use encoding schemes add latency to every encoded transfer because these transfers necessarily undergo both encoding and decoding operations. In addition, these schemes are still subject to data patterns that subvert the encoding schemes efficiency/benefits. These prior art approaches further add overhead when determining whether to switch between using encoding and not using the encoding. Further still, in implementation, encoding schemes add latency into the data path because there is minimally a multiplexor in the data path even when the encoding operation is bypassed.

In contrast, various aspects of the present disclosure for preemptive transaction scaling by limiting transactions described herein creates stall conditions in the control paths; avoiding impact to data path timing even when in use. At lower frequency and voltage conditions, any transactional impact from the preemptive transaction scaling approach disclosed herein completely disappears as no transactions are blocked, with no additional latency/timing impact in the data path. Because various aspects of the present disclosure for preemptive transaction scaling includes preemptive transaction limiting that, as its name suggests, forestalls power viruses by reducing transactions preemptively (e.g., before voltage droop events occur), no response latency exists. Thus, this scheme works for a large synchronous NoC as all the decision making about throttling is contained within each NoC node. In addition, performance penalties are limited because this scheme only stalls some transactions some of the time, and potentially not at all depending on actual NoC traffic patterns (even at high frequency and voltage).

Those of skill would further appreciate that any of the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor” and/or a “processing system”, both of which may be used interchangeably) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In addition, for other aspects the computer-readable medium may include transitory computer-readable medium (e.g., a signal). Combinations of the above should also be included within the scope of computer-readable media. In some aspects, a computer program product may comprise packaging materials.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. A “set” of elements may refer to any number of those elements, including zero elements. A set with zero elements may also be referred to as a null or empty set. Moreover, a “subset” of a set of elements may also refer to any number of those elements, including zero. In general, unless otherwise noted, the subset will contain a fewer number of elements (including zero elements) than the set from which those elements belong. Further, as applied to information or data, a subset of information or a subset of data may refer to no information or no data, respectively. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

What is claimed is:

1. A method for minimizing power virus in a network on chip comprising:
comparing an operational metric related to a node with at least one threshold, the node configured to manage communication of a first number of outbound transactions;
determining, based on the comparison, a second number of outbound transactions from the first number of outbound transactions that are allowed from the node; and
communicating the second number of outbound transactions.

2. The method of claim 1, wherein the first number of outbound transactions comprises an outbound transaction to a recipient, the method further comprising:
receiving an indication that the recipient is unable to receive the outbound transaction, wherein the determination of the second number of outbound transactions that are allowed from the node comprises an adjustment based on an operating state of the recipient.

3. The method of claim 1, wherein the first number of outbound transactions is associated with a window of n-cycles, and the determination of the second number of outbound transactions that are allowed from the node comprises:
setting a maximum number of transaction over a window of p-cycles.

4. The method of claim 1, wherein the operational metric comprises at least one of an operational voltage point or an operational frequency point and the at least one threshold comprises a voltage or frequency level above which a power virus is likely to occur, and the determination of the second number of outbound transactions that are allowed from the node comprises:
reducing the second number of outbound transactions to be less than the first number of outbound transactions when the operational metric exceeds the threshold.

5. The method of claim 1, wherein the operational metric comprises a number of existing packets being transmitted, and the determination of the second number of outbound transactions that are allowed from the node comprises:
limiting a maximum number of wires in a set of wires that can be toggled for the second number of outbound transactions from the node for any new packets.

6. The method of claim 1, wherein each transaction in the first number of outbound transactions comprises a priority level, and the determination of the second number of outbound transactions that are allowed from the node comprises:
allowing only transactions above a predetermined priority level to be included in the second number of outbound transactions.

7. The method of claim 1, wherein the operational metric comprises a level of activity of the node, and the determination of the second number of outbound transactions that are allowed from the node comprises:
setting the second number of outbound transactions to limit an amount of change to the activity level of the node.

8. The method of claim 1, wherein each transaction in the first number of outbound transaction comprises a switching of one or more wires from a set of wires, wherein the communication of the second number of outbound transactions comprises:
limiting a maximum number of wires in the set of wires that can be switched from a first state to a second state for the second number of outbound transactions from the node.

9. The method of claim 1, wherein the determination of the second number of outbound transactions that are allowed from the node is based on at least one of: a present voltage level of the node relative to a predetermined voltage level; and a current temperature of the node.

10. The method of claim 1, wherein each transaction in the first number of outbound transaction comprises an output of signals using a corresponding transmission interface in a set of transmission interfaces and the communication of the second number of outbound transactions comprises:
generating a set of gating signal configured to disable at least one transmission interface in the set of transmission interfaces.

11. An apparatus for minimizing power virus in a network on chip comprising:
a metrics monitor comprising an operational metric related to a node configured to manage communication of a first number of outbound transactions;
a processing system configured to:
compare the operational metric with at least one threshold; and
determine, based on the comparison, a second number of outbound transactions from the first number of outbound transactions that are allowed from the node; and
a transaction scaling module configured to communicate the second number of outbound transactions.

12. The apparatus of 11, wherein the first number of outbound transactions comprises an outbound transaction to a recipient, wherein the processing system is further configured to:
receive an indication that the recipient is unable to receive the outbound transaction, wherein the determination of the second number of outbound transactions that are allowed from the node comprises an adjustment based on an operating state of the recipient.

13. The apparatus of 11, wherein the first number of outbound transactions is associated with a window of n-cycles, and the determination of the second number of outbound transactions that are allowed from the node by the processing system comprises:
setting a maximum number of transaction over the window of p-cycles.

14. The apparatus of 11, wherein the operational metric comprises at least one of an operational voltage point or an operational frequency point and the threshold comprises a voltage or frequency level above which a power virus is likely to occur, and the determination of the second number of outbound transactions that are allowed from the node by the processing system comprises:
reducing the second number of outbound transactions to be less than the first number of outbound transactions when the operational metric exceeds the threshold.

15. The apparatus of 11, wherein the operational metric comprises a number of existing packets being transmitted, and the determination of the second number of outbound transactions that are allowed from the node by the processing system comprises:
limiting a maximum number of wires in a set of wires that can be toggled for the second number of outbound transactions from the node for any new packets.

16. The apparatus of 11, wherein each transaction in the first number of outbound transactions comprises a priority level, and the determination of the second number of outbound transactions that are allowed from the node by the processing system comprises:
allowing only transactions above a predetermined priority level to be included in the second number of outbound transactions.

17. The apparatus of 11, wherein the operational metric comprises a level of activity of the node, and the determination of the second number of outbound transactions that are allowed from the node by the processing system comprises:
setting the second number of outbound transactions to limit an amount of change to the activity level of the node.

18. The apparatus of 11, wherein each transaction in the first number of outbound transaction comprises a switching of one or more wires from a set of wires, wherein the communication of the second number of outbound transactions by the transaction scaling module comprises:
limiting a maximum number of wires in the set of wires that can be switched from a first state to a second state for the second number of outbound transactions from the node.

19. The apparatus of 11, wherein each transaction in the first number of outbound transaction comprises an output of signals using a corresponding transmission interface in a set of transmission interfaces and the communication of the second number of outbound transactions by the transaction scaling module comprises:
generating a set of gating signal configured to disable at least one transmission interface in the set of transmission interfaces.

20. The apparatus of 11, wherein each transaction in the first number of outbound transaction comprises a switching of one or more wires from a set of wires and the metrics monitor is further configured to determine how many wires of the set of wires have switched using one or more XOR gates.

21. An apparatus for minimizing power virus in a network on chip comprising:
means for comparing, with at least one threshold, an operational metric related to a node configured to manage communication of a first number of outbound transactions;
means for determining, based on the comparison, a second number of outbound transactions from the first number of outbound transactions that are allowed from the node; and
a set of transmission interfaces configured to communicate the second number of outbound transactions.

22. The apparatus of claim 21, wherein the first number of outbound transactions comprises an outbound transaction to a recipient, the apparatus further comprising:
means for receiving an indication that the recipient is unable to receive the outbound transaction,
wherein the means for determining the second number of outbound transactions that are allowed from the node comprises means for adjusting the second number of outbound transactions based on an operating state of the recipient.

23. The apparatus of claim 21, wherein the operational metric comprises a number of existing packets being transmitted, and the means for determining the second number of outbound transactions that are allowed from the node comprises:
means for limiting a maximum number of wires in a set of wires that can be toggled for the second number of outbound transactions from the node for any new packets.

24. The apparatus of claim 21, wherein each transaction in the first number of outbound transaction comprises a switching of one or more wires from a set of wires, wherein the means for communicating the second number of outbound transactions comprises:
means for limiting a maximum number of wires in the set of wires that can be switched from a first state to a second state for the second number of outbound transactions from the node.

25. The apparatus of claim 21, wherein each transaction in the first number of outbound transaction comprises an output of signals using a corresponding transmission interface in a set of transmission interfaces and the means for communicating the second number of outbound transactions comprises:
means for generating a set of gating signal configured to disable at least one transmission interface in the set of transmission interfaces.

26. A computer program product, comprising:
a computer-readable storage medium comprising code for:
comparing an operational metric related to a node with at least one threshold, the node configured to manage communication of a first number of outbound transactions;
determining, based on the comparison, a second number of outbound transactions from the first number of outbound transactions that are allowed from the node; and
communicating the second number of outbound transactions.

27. The computer program product of claim 26, wherein the first number of outbound transactions is associated with a window of n-cycles, and the code for determining the second number of outbound transactions that are allowed from the node comprises:
code for setting a maximum number of transaction over the window of p-cycles.

28. The computer program product of claim 26, wherein the operational metric comprises at least one of an operational voltage point or an operational frequency point and the threshold comprises a voltage or frequency level above which a power virus is likely to occur, and the code for determining the second number of outbound transactions that are allowed from the node comprises:
code for reducing the second number of outbound transactions to be less than the first number of outbound transactions when the operational metric exceeds the threshold.

29. The computer program product of claim 26, wherein the operational metric comprises a level of activity of the node, and the code for determination of the second number of outbound transactions that are allowed from the node comprises:
code for reducing the second number of outbound transactions to be less than the first number of outbound transactions to limit an amount of change to the activity level of the node.

30. The computer program product of claim 26, wherein each transaction in the first number of outbound transactions comprises a priority level, and the code for determining the second number of outbound transactions that are allowed from the node comprises:
code for allowing only transactions above a predetermined priority level to be included in the second number of outbound transactions.
